(19) United States
(12) Patent Application Publication
(10) Pub. No.: US 2005/0011281 A1
(43) Pub. Date: Jan. 20, 2005

(54) Method and apparatus for system integrity monitoring in spraying applications with self-cleaning showers

(75) Inventor: Lieven Wulteputte, (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Spraying Systems Co., Wheaton, IL (US)

(21) Appl. No.: 10/603,869

(22) Filed: Jun. 25, 2003

(51) Int. Cl. G01F 13/00

(52) U.S. Cl. 73/861.41

(57) ABSTRACT

A control system for monitoring the performance of one or more spray nozzles measures variables such as total liquid flow rate and liquid pressure of spray being delivered to the spray nozzles and provides a sensing signal when the difference, at a given liquid pressure, between a calculated liquid flow rate and an actual liquid flow rate exceeds an error.

### FIELD OF THE INVENTION

This invention generally relates to spray control systems and more particularly, the invention relates to spray control systems that continuously monitor nozzle characteristics in industrial spray shower applications and provide appropriate action when the nozzle characteristics exceed a permissible deviation.

### BACKGROUND OF THE INVENTION

Industrial spraying systems are used in a variety of wide ranging applications. These include applications for the pulp and paper industry, waste recycling, steel fabrication, environmental control, and power generation, among others. For applying liquid spray that is often recycled water in these applications, the spray systems typically utilize a variety of spray nozzles. In some instances, however, the spray nozzles used in these applications are of a single fluid design. The nozzles of this type use liquid pressure as energy to atomize and shape the exiting water droplets into the desired spray pattern. The exiting spray pattern is then typically used for cleaning and lubricating applications.

Improper functioning of the nozzles in these applications can result in several problems. Foremost among these problems is increased likelihood of breakdown of the systems in which the nozzles are used. For example, nozzle wear or blockage can result in one or more of the following: (1) clogging of the felts and/or wire used in the application due to improper fluid application; (2) increased wear on rolls and doctor blades; (3) increased water consumption; (4) reduced efficiency of the system; and (5) filter screen blockage. Accordingly, it would be advantageous to provide a manner for monitoring nozzle wear in such industrial applications.

### SUMMARY OF THE INVENTION

Accordingly, it is a general object of the invention to overcome the deficiencies of the prior art with respect to undetected nozzle wear.

It is a further object of the invention to provide continuous monitoring of operating conditions of one or more spray nozzles, known as showers, in an industrial spraying system.

It is a more specific object of the invention to provide an indication of abnormal performance of one or more spray nozzles when the operating conditions exceed a threshold variation from a known quantity.

This invention meets the above objectives with a control system and method that monitors, in real time, the operating performance of a nozzle or plurality of nozzles such as those disposed in a header for use in an industrial shower or the like. As a result of a detection of nozzle performance that fails to meet a certain criteria, the control system provides a warning signal or other indicia. In one embodiment, the system determines a deviation of a measured fluid flow rate in comparison to a calculated flow rate at a known operating liquid pressure. When the measured flow rate exceeds or is below a set allowable percentage error, the system generates a signal indicative of a poor nozzle performance. In this way, the system detects nozzle wear, partial nozzle blockage and other abnormal nozzle operating characteristics.

In one illustrative embodiment, the system detects nozzle performance by measuring a flow rate outside an allowable error percentage error. In this instance, the system compares an actual nozzle flow rate at a known operating pressure with a calculated flow rate at that pressure. Based on the results, the system determines that the nozzles in the header are partially blocked or worn. In response, the system automatically initiates a cleaning cycle to correct the partial blockage, initiates an alarm, or otherwise takes corrective action.

### BRIEF DESCRIPTION OF THE DRAWINGS

FIG. 1 is a schematic block diagram of a shower system in a manufacturing plant or the like according to the present invention; and

FIG. 2 is an electronic control system for use in the plant shown in FIG. 1.

### DETAILED DESCRIPTION OF THE INVENTION

The present invention generally relates to a control system that monitors various operating parameters of a spray control system used in industrial spray systems. The control system monitors parameter such as the flow rate of liquid passing through one or more spray nozzles, such as the flow of liquid through a nozzle header that is part of a spray shower. The system processes the monitored flow rate and, in response, provides an output signal indicative of system performance when the measured flow rate exceeds a limit.

The invention has particular applicability to the industrial applications such as in the pulp and paper industry, waste recycling, steel fabrication, environmental control and power generation. Various specific spray applications within these general areas include lubrication showers, doctor showers, high pressure cleaning showers and screen or felt cleaning showers. The invention, however, may be used for other applications as well.

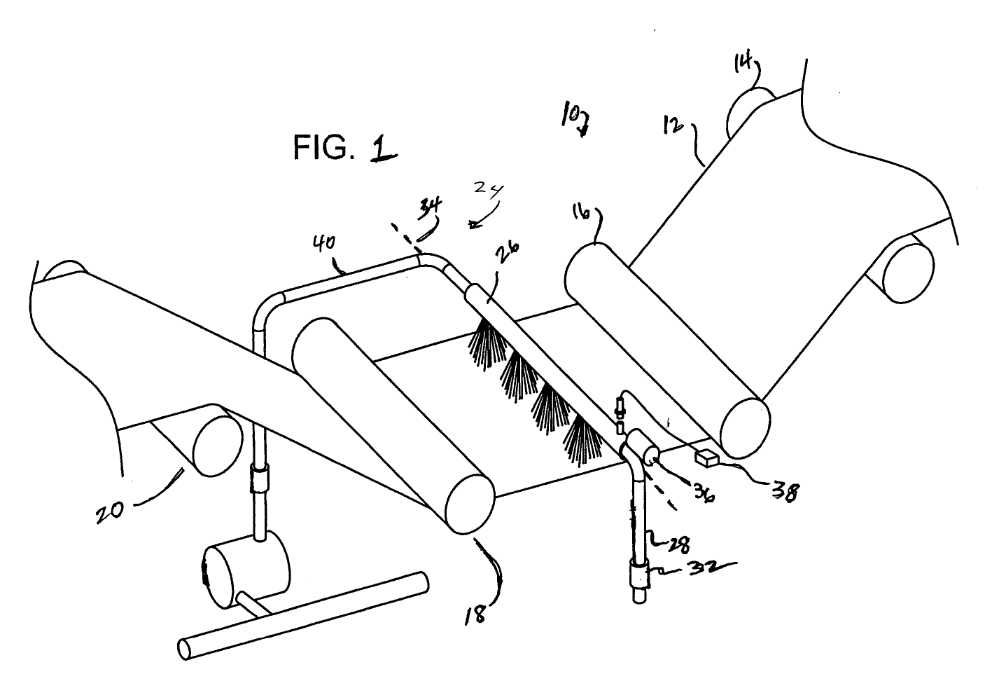

FIG. 1 is an illustrative environment for the invention. As shown therein, a pulp facility or plant 10 is operable to process a continuous web of pulp carried on a wire or felt 12 through various fabrication steps. For example, the web 12 may be passed at a desired tension over a system of rolls such as tensioning rolls 14, 16, 18, 20 during various steps in the fabrication process. The web may be further processed as will be understood by those skilled in the art.

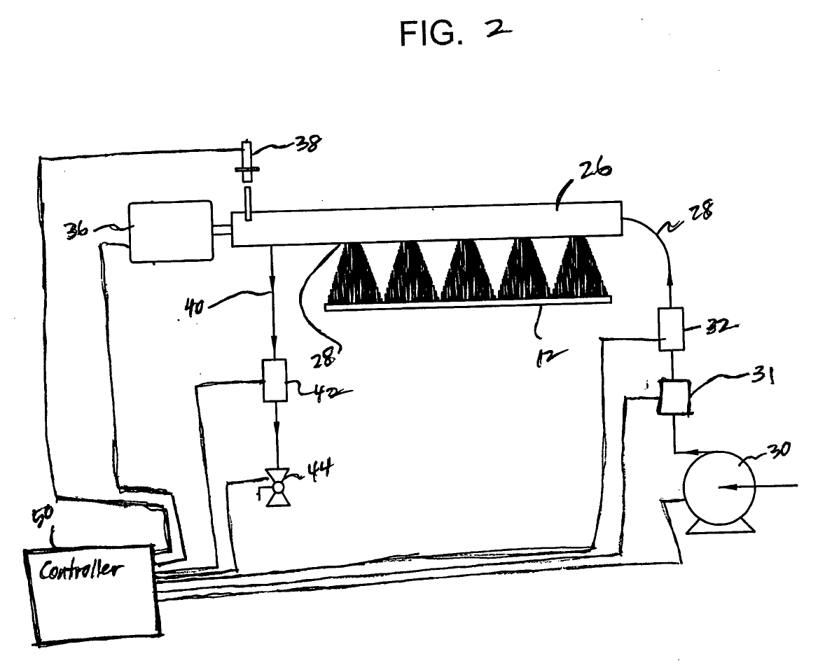

In the illustrated embodiment, a shower apparatus 24 is disposed to direct a fluid shower toward the web in a controlled fashion, namely with a particular droplet size and at a specified pressure. For example, the fluid shower may be recycled water that is used in the industrial application for cleaning or the like. Alternatively, the liquid shower may supply a liquid other than water for cleaning other operations. In either instance, the shower apparatus 24 includes a header 26 oriented in transverse relation to the direction of travel of the web. The header 26 includes a plurality of fluid nozzles such as fluid nozzle (FIG. 2). The nozzles are oriented to supply a brush shower by atomizing a liquid such as water.

For supplying the header with liquid, an inlet line 28 receives pressurized liquid from a supply. As shown in FIG. 2, a pump 30 supplies pressurized liquid to the inlet line 28. The pressurized liquid is supplied via a control valve 31 and a flow meter 32 disposed for measuring the flow rate in the inlet line 28. The liquid exits the shower header 26 through nozzles 12. Located within the exit line 40 is a pressure sensor 42 for measuring the pressure of the liquid in the system. A flush valve 44 is disposed in the exit line 40 for permitting liquid to escape the system during a cleaning cycle.

The header 26 for the spray shower in the illustrated embodiment is preferably a one and one-half to two inch tube with twelve nozzles providing a brush shower to the work. The header 26 includes a brushing mechanism disposed therein that is rotatable about an axis of rotation 34. This permits proper spraying action of the nozzles. For effecting rotating movement of the brush mechanism, a motor 36 is coupled to the header tube as shown in FIG. 1. A proximity sensor 38 is also utilized for determining the angular position of the brush mechanism within the header 26.

In accordance with the illustrated embodiment of the invention, the spray nozzles are a type that supplies a flat spray pattern, however, the invention may be employed in any number of applications wherein any type of spray nozzle is employed. One of the factors affecting performance of the shower apparatus and the overall industrial system, is nozzle performance. The primary influences of nozzle performance include nozzle wear and partial nozzle blockage. In general, such nozzles exhibit wear that is typically characterized by an increase in nozzle capacity, followed by a general deterioration of the spray pattern. By way of example, flat fan spray nozzles with elliptical orifices experience a narrowing of the spray pattern. In other spray pattern types, the distribution within the spray pattern itself deteriorates, without substantially changing coverage area. The increase in nozzle capacity can sometimes be recognized by a decrease in system operating pressure, particularly when pumping apparatus such as a positive displacement pump or the like is utilized. However, it is often difficult if not impossible to recognize slight fluctuations or wear that occur over time. Likewise, a partial nozzle blockage, which may be readily corrected, may be difficult to detect by visual inspection of the shower system alone.

FIG. 2 illustrates a block diagram of an industrial spraying system according to the present invention. As shown therein, a logical controller 50 receives various input signals and provides various output signals to the components of the spraying system. For example, the controller 50 receives an input signal from the liquid flow meter 32 indicative of a measured liquid flow to the brush shower. In addition, the controller 50 receives a signal from the pressure sensor 42 indicating the pressure of the liquid in the brush shower. The controller 50 also receives a position signal from the proximity sensor 38 indicative of the position of the brush mechanism.

In response, the controller operates in a logical fashion, as explained in further detail below, to control various parameters of the system. These include operation of the control valve 31 for controlling the flow rate of the liquid in the system. Optionally, the controller 50 may provide control signals to the fluid pump 30 for altering the pressure of the liquid supplied in the system. Also, the controller 50 provides signals to the motor 36 for changing the position of the brush mechanism of the shower.

In accordance with the invention, a control system monitors the operating parameters of the plurality of nozzles for the system. In one embodiment, the system compares a measured liquid flow rate with a calculated flow rate for the system. When the measured flow rate exceeds a certain percentage deviation from the calculated flow rate, the system provides a sensing signal indicative of the deviation or initiates other appropriate action. In this way, the system determines the operating performance of the nozzles.

For monitoring the performance of the spray nozzle(s) in the header, the spray controller derives two variables: (1) Q_{L}: Total liquid flow rate delivered to the spray nozzle(s); and (2) P_{L}: Liquid pressure to the spray nozzle(s). In the illustrated embodiment, the liquid pressure is the same for all nozzles since all nozzles shown in the shower header of FIGS. 1 and 2 depend from the same manifold liquid supply. On the other hand, where the nozzles originate from different headers or apparatus, the system determines multiple liquid flow rates at the various operating pressures.

For proper functioning spray nozzle(s), a known relationship between the two variables exists. In other words, the liquid flow rate Q_{L} is fixed at a given liquid pressure P_{L}, according to the following function (Equation 1) below:
Q_{L}=f(P_{L})

The function f is related to the type of nozzle being utilized in the shower application. This function describes the proper performance behavior of a spray nozzle (or nozzles). It is determined for a new spray nozzle(s) of the type being utilized in the system by measuring the liquid flow rates for different values liquid pressure as will be understood by those skilled in the art to which this invention pertains.

In the nozzle control system shown in FIG. 2, the variables Q_{L} and P_{L} are measured and are compared with theoretical or predetermined performance behavior characteristics. In particular, the control system uses the following declarations:
Q_{Lc}: Total calculated liquid flow rate
P_{Lm}: Measured liquid pressure
Q_{Lm}: Total measured liquid flow rate
Then, similar to the relationship noted above, the calculated flow is a function of measured liquid pressure (Equation 2) below:
Q_{Lc}=f(P_{Lm})
The system then determines that the nozzle is not performing sufficient when:

$$\frac{\vert {Q}_{Lc} - {Q}_{Lm} \vert}{{Q}_{Lc}} \geq ɛ$$

with ε=maximum allowed percentage error.
In other words, the operating nozzle or nozzles are not performing satisfactorily when the measured flow rate differs too much from the calculated flow rate at the given liquid pressure.

The relationship between the measured and calculated flow rates can also give an indication of the performance problem. It has been found that the following relationships hold true:
Q_{Lm}>Q_{Lc}: Liquid orifice(s) worn out
In this instance, the nozzle uses more liquid at given pressure conditions since the nozzle or nozzles in the system are worn.
Q_{Lm}<Q_{Lc}: Liquid orifice(s) partially blocked
On the other hand, this condition is indicative that the orifices for the nozzle are partially blocked because the nozzle uses less liquid at given pressure conditions.

In practice, the invention may be implemented by reference to a look-up table maintained by the controller 50. This table preferably includes entries corresponding to various pressure/flow relationships. Thus, the system uses a table relationship for a for certain number of calibration points. These points are preferably within the normal working range of the nozzle or nozzles being employed. Thus, for a nozzle having a normal operating range from 1.0 bar to 5.0 bar liquid pressure, a table may include entries corresponding to a calculated liquid flow rate corresponding to 1.0, 2.0, 3.0, 4.0 and 5.0 bar liquid pressure. The controller 50 then uses interpolation based on the table entries to calculate the desired flow rate at a given liquid pressure. The calculated flow rate is compared with the measured flow rate as explained above, and appropriate corrective action is provided when the difference exceeds a particular value.

For modifying the spray shower in the case wherein the measured flow rate is less than the calculated flow rate, the control system initiates a cleaning cycle. Thus, in the illustrated embodiment shown in FIG. 1, the spray shower initiates a cleaning cycle to remove the clogging or buildup of debris in the header 26 and other portions of the shower apparatus 24. This may include, among other things, opening the flush valve and causing rotation of the brush mechanism disposed within the header during a prescribed period. The rotating brush mechanism is operable to clean the respective nozzle orifices disposed on the inside of the header 26. Dirt and other debris resident in the header 26 are removed via the flush valve. After the cleaning cycle has completed, the brush mechanism is rotated to an angular position such that the nozzle orifices are unobstructed on the inside of the header 26. For determining the proper stop position and orientation of the brush mechanism, the control system obtains sensing information from the proximity sensor 38. In this way, the sensor 38 provides a sensing signal to appropriate electronics for controlling the position of the brush mechanism.

On the other hand, when the measured flow rate exceeds the calculated flow rate, the control system initiates an alarm and/or appropriate warning procedure. In some cases, the system takes other corrective action.

Accordingly, a spray shower and control system for use in the shower that meets the aforestated objectives has been described. It should be understood, however, that the foregoing description has been limited to the presently contemplated best mode for practicing the invention. It will be apparent that various modifications may be made to the invention, and that some or all of the advantages of the invention may be obtained. Also, the invention is not intended to require each of the above-described features and aspects or combinations thereof, since in many instances, certain features and aspects are not essential for practicing other features and aspects. Accordingly, the invention should only be limited by the appended claims and equivalents thereof, which claims are intended to cover such other variations and modifications as come within the true spirit and scope of the invention.

1. A control system for detecting nozzle wear in an industrial shower header including a plurality of liquid spray nozzles for orienting liquid at a predetermined pressure and droplet size comprising:
means for determining a calculated flow rate for the plurality of liquid spray nozzles at a given operating pressure;
means for continuously monitoring an actual flow rate of liquid through the nozzle header;
means for comparing the desired flow rate with the actual flow rate and creating a feedback signal when a threshold is exceeded; and
means for providing the feedback signal to the spray system to adjust an operating condition thereof.

2. The system of claim 1 wherein the feedback signal is operative to initiate a cleaning cycle or alarm warning.

3. The system of claim 1 wherein the means for determining includes a look-up table with entries for liquid flow rate at various discrete operating pressures of the nozzles.

4. The system of claim 3 wherein the means for determining includes means for interpolating between the discrete operating pressures for providing an operating pressure for the nozzles.

5. A method for monitoring the performance of a spray nozzle in an industrial spraying system including the steps of control system for controlling the pressure of liquid applied to a nozzle comprising:
calculating a liquid flow rate value for a nozzle header at a desired pressure to derive a calculated liquid flow rate value;
measuring an actual flow rate of liquid applied at the desired pressure through the nozzle header to derive an actual flow rate value;
comparing the actual flow value with the calculated flow rate value;
determining whether the actual flow exceeds a percentage error deviation from the measured flow rate value; and
providing an output signal when the percentage error exceeds a certain value.

6. A spray controller for providing a signal indicative of nozzle performance detection in an industrial shower header including one or more liquid spray nozzles for orienting liquid spray at a certain operating pressure and droplet size comprising:
means for determining a calculated flow rate for the one or more liquid spray nozzles at a given operating pressure;
means for continuously monitoring an actual flow rate of liquid through the nozzle header;
means for comparing the desired flow rate with the actual flow rate and creating a feedback signal when a threshold is exceeded; and
means for providing the feedback signal to the spray system to adjust an operating condition thereof.
